(19) United States
(12) Patent Application Publication
(10) Pub. No.: US 2009/0082960 A1
(43) Pub. Date: Mar. 26, 2009

(54) NAVIGATION SYSTEM WITH ENHANCED DISPLAY FUNCTIONS

(75) Inventors: Deepak Ramaswamy, Superior Township, MI (US); Katsuaki Tanaka, West Bloomfield, MI (US)

Correspondence Address: GIFFORD, KRASS, SPRINKLE,ANDERSON & CITKOWSKI, P.C, PO BOX 7021, TROY, MI, 48007-7021, US

(73) Assignee: Xanavi Informatics Corporation, Kanagawa-Ken (JP)

(21) Appl. No.: 11/861,522

(22) Filed: Sep. 26, 2007

(51) Int. Cl. G01C 21/30

(52) U.S. Cl. 701/211

(57) ABSTRACT

A method and apparatus for enhancing a user's visual perception of map data in a navigation system of the type used in automotive vehicles. A portion of an object, such as a building, is selected on the screen and a perspective view of the three-dimensional map data corresponding to the selected portion of the object is then depicted on the display screen. In a second form, a map is displayed on the display screen together with the route between the current position of the vehicle and a desired vehicle destination. A portion of the route is selected between the current position of the vehicle and the vehicle destination while the expected time for the vehicle to reach the selected portion is then displayed on the display screen.

### BACKGROUND OF THE INVENTION

I. Field of the Invention

The present invention relates generally to navigation systems and, more particularly, to a navigation system with an enhanced visual display function.

II. Description of Related Art

Navigation systems of the type used in automotive vehicles have enjoyed increasing popularity. Such navigation systems typically include a display screen on which map data is displayed. Such navigation systems also include processors which compute the most desirable route from the current position of the vehicle and to a destination selected by the user and that route information is also displayed on the display screen.

The previously known navigation systems, however, have typically displayed only two-dimensional (2D) map data on the display screen. As such, these previously known navigation systems fail to provide a perspective view of the map data, i.e. the view that is actually seen by the operator of the vehicle.

A still further disadvantage of these previously known navigation systems is that, although the route information from the current position of the vehicle and to a user inputted destination is clearly shown on the display screen, the travel times to points intermediate the position of the vehicle and the destination are unknown. In many instances, however, it would be desirable to know the approximate arrival times of the vehicle at intermediate points along the route. Similarly, in many situations it would be helpful to estimate the position of the vehicle along the route as a function of time.

### SUMMARY OF THE PRESENT INVENTION

The present invention provides a navigation system which overcomes all of the above-mentioned disadvantages of the previously known navigation systems.

In brief, in one embodiment of the present invention, the navigation system has access to both 2D and 3D map data. The 2D map data is displayed on the display screen for the navigation system in the conventional fashion. Such a display includes many different types of objects, such as buildings, golf courses, shopping facilities, etc., in addition to the road link data.

In order to enhance the visual display for the user of the navigation system, an object, such as a building, is selected by the user in any conventional fashion, such as through a touch screen, joystick or other input device.

Once selected, the navigation system accesses a three-dimensional map database to display the selected object together with its surroundings on the display screen in a perspective view, i.e. the type of view that would actually be seen by the operator of the vehicle. Furthermore, the display of the actual perspective view on the screen would vary as a function of which portion or side of the object is selected. For example, a perspective view of a building from the east side of that building would be different than the perspective view from the west side of the building.

As a further enhancement, the navigation system of the present invention, like other navigation systems, displays route information on the display screen, i.e. the most desirable path of travel from the current position of the vehicle and to a destination selected or inputted by the vehicle operator. However, unlike the previously known navigation systems, the vehicle operator may select intermediate points along the displayed route whereupon the navigation system displays the approximate time to that selected intermediate position of the route.

Different means may be utilized by the operator to select an intermediate point along the route between the current position of the vehicle and the destination. In one form of the invention, one or more sliders are also displayed on the screen. These sliders are then manipulated by the user, either through a touch screen function of the display screen, or by other input device, so that the slider intersects the desired intermediate point along the route between the current vehicle position and the destination.

As a still further enhancement of the present invention, the projected position of the vehicle along the route may be displayed as a function of time which is selected and/or varied by the vehicle operator. In one embodiment of the invention, a slider is displayed on the vehicle touch screen to vary the future time between the present time and a future time. Consequently, the projected position of the vehicle along the route is displayed and varied along the route as a function by the position of the slider and thus as a function of the future time. The future time selected by the user is also displayed on the navigation system display screen.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a simplified block diagrammatic view illustrating a preferred embodiment of the present invention;

FIG. 2 is a simplified exemplary map illustrating a plurality of objects;

FIGS. 3A and 3B are exemplary perspective views of the type displayed by the navigation system of the present invention;

FIG. 4 is a flowchart illustrating the operation of the navigation system of the present invention; and

FIG. 5 is an exemplary view of a portion of a map illustrating a still further enhancement of the navigation system of the present invention.

### DETAILED DESCRIPTION OF PREFERRED EMBODIMENTS OF TEE PRESENT INVENTION

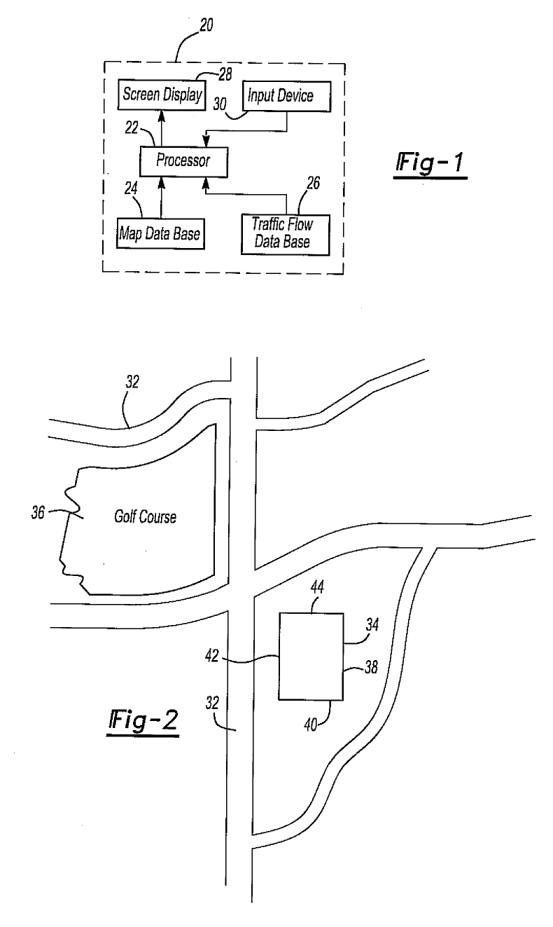

With reference first to FIG. 1, a simplified block diagrammatic view of a navigation system 20 is shown. The navigation system 20 includes a processor 22 for producing route calculations and other types of navigation display functions.

The processor 22 accesses both a map database 24, which is preferably a three-dimensional (3D) map database, to obtain the road link data for the map display and for the route calculations of the navigation system 20. The processor 22 also accesses a traffic flow database 26 which contains traffic flow data for the various road links in the map database 24. The information from the traffic flow database 26 is utilized by the processor 22 when performing the route calculations for the navigation system 20.

Still referring to FIG. 1, the navigation system 20 includes a display screen 28 on which both the map data and route calculations are displayed. An input device 30 enables the operator of the vehicle for the navigation system 20 to input information, such as the desired destination for the vehicle. Any conventional input device 30 may be utilized such as a keypad, joystick or touch screen associated with the display screen 28. Indeed, the input device 30 may comprise a multi-axis gyro sensor which may be manipulated by the vehicle operator.

With reference now to FIG. 2, a simplified map view of the type that will be displayed on the display screen 28 is shown. This view includes a plurality of roads 32 as well as other objects, such as one or more buildings 347 golf courses 36 and the like. Each object 34 and 36, furthermore, includes different sides, such as an east side 38, south side 40, west side 42 and north side 44 of the building 34.

In order to enhance the display of the navigation system 20, the top or any side of an object 34 or 36, such as one of the sides 38-44 of the building, may be selected by the vehicle operator using the input device 30 (FIG. 1). Upon doing so, the processor 22 accesses the map database 24 and displays a plan or face view of the top or side of the object selected by the input device 30 on the screen 28.

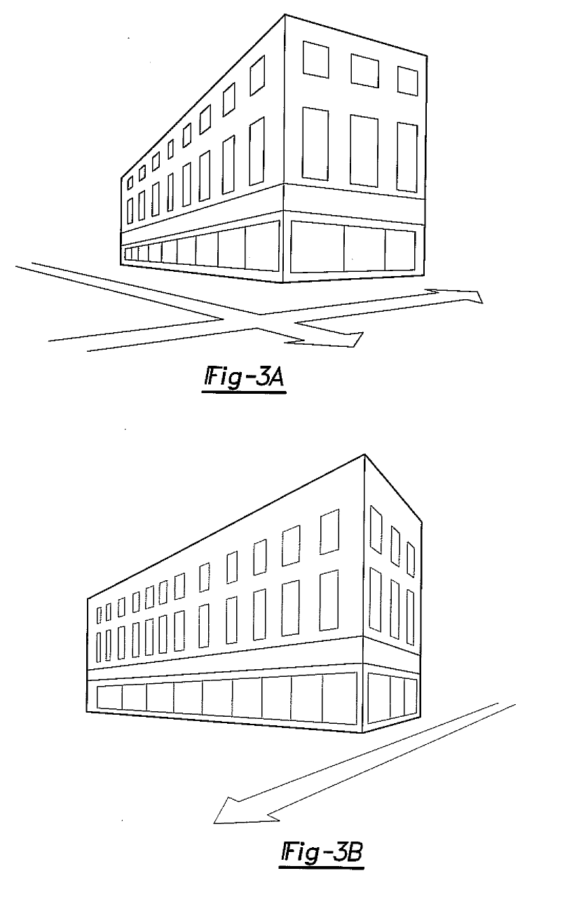

Once an object 34 or 36 has been selected, the plan or face view displayed on the display screen 28 may be manipulated by the input device 30 by continuous or multi-touch to view the object in different perspective angles, such as shown in FIGS. 3A and 3B. For example, the input device 30 may be used to rotate around the object 34 to display the perspective view as seen from different sides 38-44 of the object 34 such as shown in FIG. 3B. Furthermore, the data for the various objects 34 is contained in the map database 24 (FIG. 1).

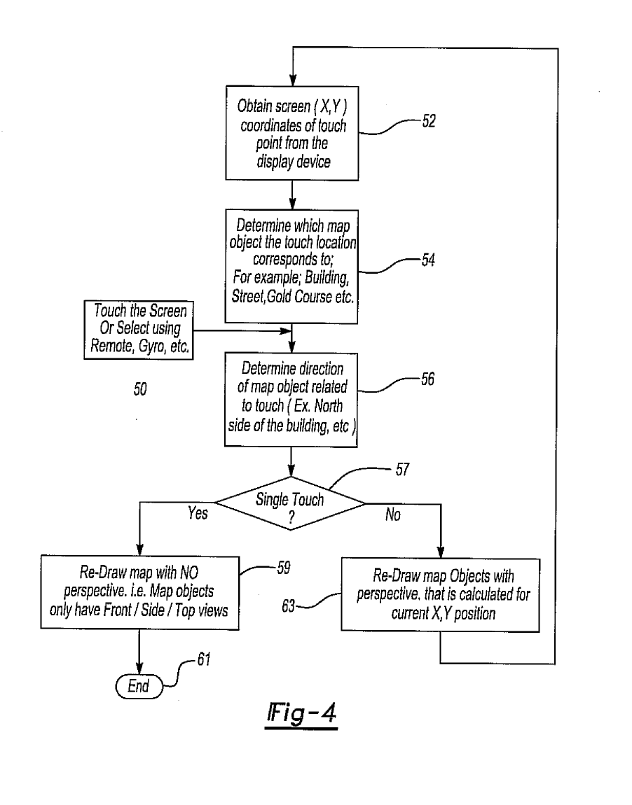

With reference now to FIG. 4, a flowchart illustrating the operation of the present invention is shown. At step 50, the operator of the navigation system selects the desired object, such as the building 34 (FIG. 2), by the input device 30. Where the input device 30 comprises a touch screen associated with the display screen 28 for the navigation system 20, the user merely touches the object for which a perspective view is desired on the touch screen.

Step 50 then proceeds to step 52 where the processor 22 obtains the X, Y coordinates of the selected object on the screen. Step 52 then proceeds to step 54.

At step 54 the processor 22 determines which map object in the map database 24 corresponds to the selected X, Y position inputted by the user. Step 54 then proceeds to step 56.

At step 56, the processor determines the direction of the object selected at step 52. For example, step 56 determines which side 38-44 of the object 34 that has been selected by the vehicle operator. Step 56 then proceeds to step 57.

At step 57 the algorithm determines whether the input selection by the operator constituted a single touch or a continuous or multi-touch. If a single touch occurred, the algorithm branches to step 59 and displays the plan view of the selected top or selected side of the object on the screen by using data from the 3D map database 24. Step 59 then proceeds to step 61 and ends the algorithm until the next operator selection.

Conversely, if the selection or touch is continuous or a multi-touch, step 57 instead branches to step 63 where a perspective view of the selected object is displayed on the screen 28 as shown in FIG. 3A while using the currently selected X, Y position on the screen 28. Step 63 then proceeds back to step 52 where the above process is repeated. In this way a perspective view of the selected object is not only displayed on the screen, but also manipulated as desired by the operator, for example, from the position shown in FIG. 3A and to the position shown in FIG. 3B.

Consequently, from the foregoing it can be seen that the present invention provides a greatly enhanced visual output for the display screen of the navigation system which permits the various locations and objects on the display screen to be viewed in a similar perspective as would be seen by the operator of the motor vehicle. This in turn enhances the overall utility of the navigation system.

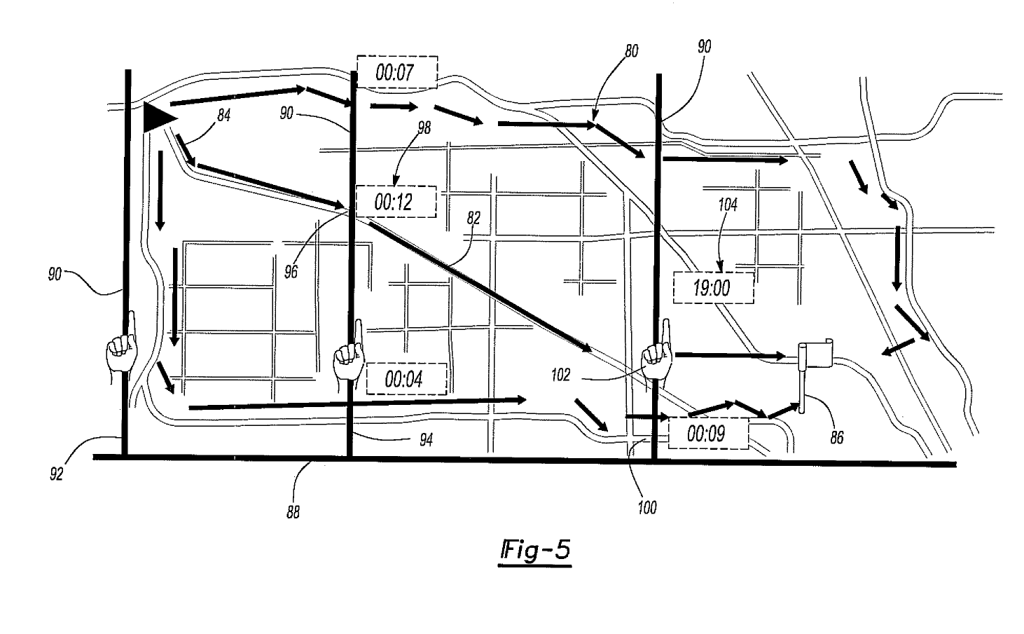

With reference now to FIG. 5, a still further enhancement for the navigation system 20 is shown in which a portion of a map 80 is displayed on the display screen 28. Additionally, a route 82 from a current position 84 of the vehicle and to a destination 86 (which may or may not appear on the display screen 28 depending upon the distance units displayed on the display screen 28) has also been calculated by the processor 22 and displayed on the display screen 28. Additionally, at least one and preferably two sliders 88 and 90 are also displayed on the screen 28 and preferably these sliders 88 and 90 are perpendicular to each other.

Upon movement of the slider from the position shown at 92 and, for example, to the position shown at 94, the slider 90 intersects the route 82 at a position 96 intermediate the current position 84 of the vehicle and the destination 86. On doing so, the processor 22 displays the projected time to reach the portion 96 of the route 82 visually on the screen 28 as shown at 98.

Similarly, by again moving the cursor 90 to the position shown at 100, the slider 90 intersects the route 82 at a route position 102 intermediate the current position 84 of the vehicle and the destination 86. Upon doing so, the processor displays the estimated time to reach the route portion 102 on the display screen 28 as shown at 104.

The second slider 88 operates in the same fashion, but in a perpendicular direction, to the slider 90. Consequently, no further description thereof is required. Furthermore, any conventional means may be used to move the sliders 90 and/or 88, such as a joystick, touch pad on the display screen 28 and the like.

From the foregoing, it can be seen that the present invention provides several methods and apparatus to enhance the overall operation and display of a vehicle navigation system. Furthermore, although the present invention has been described for use as a vehicle navigation system, it will be understood, of course, that it may be used in any type of navigation system without deviation from the spirit or scope of the invention.

Having described our invention, however, many modifications thereto will become apparent to those skilled in the art to which it pertains without deviation from the spirit of the invention as defined by the scope of the appended claims.

We claim:

1. A method for enhancing a user's visual perception of map data in a navigation system containing a video display screen comprising the steps of:
selecting a portion of an object on the screen,
displaying a perspective view of map data corresponding to the selected portion of the object on the display screen.

2. The invention as defined in claim 1 and further comprising the steps of:
manipulating the position of the selected object on the screen, and
displaying a perspective view of map data corresponding to the manipulated position of the object on the display screen.

3. The invention as defined in claim 2 wherein the screen is a touch screen and wherein said manipulating step comprises the step of rotating said object by touching and drawing a movement on the screen.

4. The invention as defined in claim 2 wherein the navigation system includes an input device separate from the display screen and wherein said manipulating step comprises the step of manipulating said input device.

5. The invention as defined in claim 4 wherein said input device comprises a joystick.

6. The invention as defined in claim 1 wherein the screen is a touch screen and wherein said selecting step comprises the step of selecting said portion of said object by touching said portion on the screen.

7. The invention as defined in claim 1 wherein said selecting step comprises the step of identifying the boundaries of the object.

8. In a vehicle navigation system having a display screen a method for displaying route information comprising the steps of:
displaying a map on said display screen,
displaying a route between a current position of the vehicle and a destination on said map on said display screen,
selecting a portion of said route between the current position of the vehicle and the vehicle destination,
displaying an expected time for the vehicle to reach said portion of said route on the display screen.

9. The invention as defined in claim 8 wherein said selecting step comprises the step of displaying at least one slider on the display screen which slider extends across the display screen and moving said slider until said slider intersects said portion of said route.

10. The invention as defined in claim 9 wherein said display screen is a touch screen and wherein said moving step comprises the step of dragging the slider on the touch screen.

11. The invention as defined in claim 9 and comprising the step of displaying two sliders on said display screen, said sliders being perpendicular to each other.

12. In a vehicle navigation system having a display screen a means for displaying route information comprising:
means for displaying a map on said display screen,
means for displaying a route between a current position of the vehicle and a destination on said map on said display screen,
at least one slider on the display screen which slider extends across the display screen and means for moving said slider until said slider intersects said portion of said route,
means for displaying an expected time for the vehicle to reach said portion of said route on the display screen.

13. In a vehicle navigation system having a display screen a method for displaying route information comprising the steps of:
displaying a map on said display screen,
displaying a route between a current position of the vehicle and a destination on said map on said display screen,
selecting a future time, and
displaying an expected position of the vehicle on said route at said future time on the display screen.

14. The invention as defined in claim 13 wherein said selecting step comprises the step of displaying at least one slider on the display screen and moving said slider until said future time is displayed on the display screen.
